(19) United States
(12) Patent Application Publication
(10) Pub. No.: US 2024/0289445 A1
(43) Pub. Date: Aug. 29, 2024

(54) STORAGE SYSTEM AND STORAGE SYSTEM MONITORING METHOD

(71) Applicant: Hitachi, Ltd., Tokyo (JP)

(72) Inventors: Kazuma SASAKI, Tokyo (JP); Shigeki ARATA, Tokyo (JP); Yuri HIRAIWA, Tokyo (JP); Kenichi OYAMADA, Tokyo (JP); Akira NIKAIDO, Tokyo (JP); Hironobu SAKATA, Tokyo (JP)

(21) Appl. No.: 18/232,558

(22) Filed: Aug. 10, 2023

(30) Foreign Application Priority Data
Feb. 28, 2023 (JP) 2023-029083

(51) Int. Cl. G06F 21/55; G06F 11/14

(52) U.S. Cl. CPC G06F 21/554; G06F 11/1448; G06F 11/1456; G06F 21/552

(57) ABSTRACT

Detect server attack due to ransomware attacks, etc., without increasing the system load using metrics that are normally monitored. A storage system comprising a first storage connected to the server running the application, a data protection storage to get a backup of the first storage, a monitoring server monitoring the data protection storage, wherein the monitoring server comprising backup execution unit that backup data from the first storage to the data protection storage, an amount of data written monitoring unit determines abnormality when the amount of data written to the data protection storage exceed predetermined amount and, an output part issue alert when the amount of data written monitoring unit determines an abnormality.

### CROSS-REFERENCE TO RELATED APPLICATION

The present application claims priority from Japanese application JP2023-029083, filed on Feb. 28, 2023, the content of which is hereby incorporated by reference into this application.

### TECHNICAL FIELD

This invention relates to storage systems and methods of monitoring storage systems.

### BACKGROUND ART

There is remote copy, which stores backup data at a remote site and restores the data using the backup data when a failure occurs. For example, in Patent Document 1 (JP-A-2006-146801), the remote copy technique restricts access to each host computer to prevent other host computers from accidentally destroying the data in the remote volume.

There is a patent document 2 on so-called anomaly detection, which determines that a storage system may have been cyber-attacked based on metrics obtained from the storage system. In Patent Document 2, multiple snapshots of a storage volume are generated, a specific snapshot is monitored against the current snapshot, and an alert is output indicating a possible ransomware attack, such as when the compression ratio of a storage volume falls below a specified compression ratio.

### CITATION LIST

### Patent Document

Patent Documents 1 Japanese Unexamined Patent Publication JP-A-2006-146801

Patent documents 2 U.S. Pat. No. 11,030,314 B2

### SUMMARY OF THE INVENTION

### Problems to be Solved by the Invention

Patent document 1 discloses that a remote copy function is used to obtain multiple backups of data in case of a failure, but it does not disclose how the failure is detected.

In Patent Document 2, multiple snapshots are taken from a storage volume, and the possibility of a ransomware attack is detected based on conditions such as whether the compression ratio of the storage volume is below a specified value.

However, conditions such as the compression ratio of storage volumes are greatly affected by the operating status of the Application running on the Production server, and it is difficult to correctly output an alert indicating failure due to a ransomware attack due to changes in operating status. In addition, not only is it difficult for users to set threshold values for changes, but also in order to more accurately detect failures, it is necessary to acquire metrics that are not normally monitored, which may lead to increased system load.

In addition, monitoring metrics on Production storage that is accessed by the Production server increases the load on the production storage and may cause delays in the services provided by the Production server.

The purpose of this invention is to detect server attack due to ransomware attacks, etc., in storage systems that are backing up data by remote copying, without increasing the system load using metrics that are normally monitored.

The invention has a storage system comprising a first storage connected to the server running the application, a data protection storage to get a backup of the first storage, a monitoring server monitoring the data protection storage, wherein the monitoring server comprising backup execution unit that backup data from the first storage to the data protection storage, an amount of data written monitoring unit determines abnormality when the amount of data written to the data protection storage exceed predetermined amount and, an output part issue alert when the amount of data written monitoring unit determines an abnormality.

### Effects of the Invention

Failures due to server attacks can be detected based on changes in the amount of data writes, a metric normally monitored by storage systems that acquire backups.

### BRIEF DESCRIPTION OF DRAWINGS

FIG. 1: Example of a block diagram showing an example of the system configuration in an example of the invention.

FIG. 2 (a): Example of a system to which the invention can be applied.

FIG. 2 (b): Example of a system to which the invention can be applied.

FIG. 2 (c): Example of a system to which the invention can be applied.

FIG. 3: Comparison of data write volume between business storage volume and data protection storage volume.

FIG. 4: Advantages of monitoring the amount of write data on data protection storage volumes.

FIG. 5: Example of backup plan table in the example of this invention.

FIG. 6: Example of backup control tables in the example of this invention.

FIG. 7: Example of threshold table in the example of this invention.

FIG. 8: Example of threshold values set in the threshold table and metric measurements of a protected storage volume in the example of this invention.

FIG. 9 (a): Example of anomaly event table in the example of this invention.

FIG. 9 (b): Example of anomaly event table in the example of this invention.

FIG. 10: Examples of anomaly event table values and metric measurements of protected storage volumes in the example of this invention.

FIG. 11: Example of backup execution unit flowchart in the example of this invention.

FIG. 12: Example of a flowchart of the amount of data written monitoring unit in the example of the present invention.

FIG. 13: Example of abnormal event recorder flowchart in this example.

FIG. 14: Example of an output screen in an example of the invention.

FIG. 15: Example of a block diagram showing an example of the system configuration in this example.

FIG. 16: Example of a flowchart of the amount of data written monitoring unit in the example of the present invention.

### MODE FOR CARRYING OUT THE INVENTION

One embodiment of the invention is described below according to the drawings.

However, the invention is not limited to the examples described below, but includes various variations and equivalent configurations within the scope of the appended claims. For example, the aforementioned examples are described in detail for the purpose of explaining the invention in an easy-to-understand manner, and the invention is not necessarily limited to those having all the described configurations.

In this example, each information is described in a “table” format, but this information does not necessarily have to be expressed in a table data structure, and may be expressed in a data structure such as a DB (Data Base).

Therefore, “table”, “DB”, etc. are sometimes simply referred to as “information” to indicate that they are independent of the data structure. In addition, the expressions “identification information, ” “identifier, ” and “ID (IDentification) ” can be used to describe the contents of each piece of information, and these can be substituted for each other.

Programs, tables, files, and other information that realize each function can be stored in memory, hard disks, SSD (Solid State Drive), or other storage devices, or in recording media such as IC cards, SD cards, and DVDs.

In addition, each of the aforementioned components, functions, processing means, etc., may be realized in hardware by designing some or all of them in an integrated circuit, for example, or in software by having a processor interpret and execute a program to realize each function.

In the following explanations, the program such as “XX part” may be used as the subject of the explanation, but since the program is executed by the processor to perform the process defined by the processor using memory 3 and external storage devices 4, the processor may also be used as the subject of the explanation. The explanation may be made with the processor as the subject.

### EXAMPLE 1

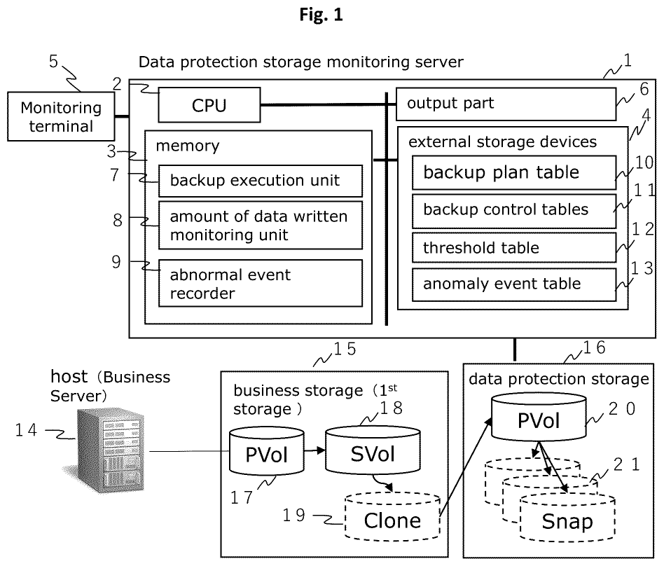

FIG. 1 is an example of a block diagram showing an example system configuration in this invention. In business storage 15, a physical volume (primary volume, PVol) 17 contains the data used by host 14, and a local copy of PVol 17, a copy of PVol 17, is stored in SVol 18. A clone 19 of the data in SVol is created and mapped to the physical volume (PVol) 20 in data protection storage 16 and a copy of the physical volume 17 is taken in data protection storage. A copy of the physical volume 17 is taken into data protection storage.

PVol 20 is taken snapshot 21 and generation management is performed. These processes are executed under the direction of Data protection storage monitoring server 1, which is network-connected to data protection storage 16.

Data protection storage monitoring server 1 includes CPU (Central Processing Unit) 2, memory 3 and external storage devices 4 connected by bus. Memory 3 contains backup execution unit 7, amount of data written monitoring unit 8 and abnormal event recorder 9 are stored in memory 3 as software modules, and external storage devices 4 contain backup plan table 10, backup control tables 11, threshold table 12, and anomaly event table 13 are stored in external storage devices 4.

Each software module in memory 3 refers to a table stored in external storage devices 4 to monitor data protection storage 16.

Monitoring terminal 5 is also connected to data protection storage monitoring server 1, and users can view the monitoring status of data protection storage from monitoring terminal 5. You can change the backup time and set and change thresholds to detect anomalies. The monitoring terminal 5 does not need to be directly connected to the data protection storage monitoring Server 1, but may be connected via a network.

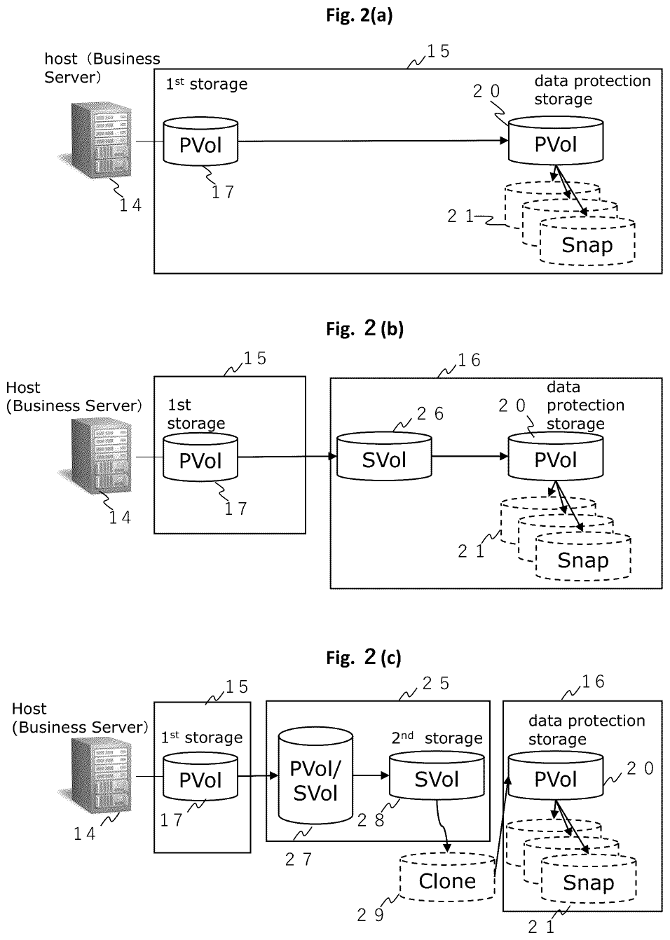

FIG. 2 illustrates an example of data protection storage 16 to be monitored. FIG. 2 (a) shows an example of a system in which the primary storage 15 and data protection storage 16 directly used by host 14 are implemented on the same storage and do not have a local copy (SVol). Since the primary storage 15 and data protection storage 16 are not far apart, the communication delay required for backup is small and inexpensive backup is possible, but since there is no SVol, there are problems such as the time required to restore operations in the event of a failure and the susceptibility to large-scale disasters, there are problems such as being susceptible to large-scale disasters.

FIG. 2 (b) shows an example in which the first storage 15 directly used by host 14 and data protection storage 16 are implemented separately. In this example, Svol 26, which stores a local copy, is placed in data protection storage 16, and since SVol 26 and PVol 20 are placed in data protection storage 16, a relatively inexpensive backup that enables business operations to be restored in a short time in the event of a failure is possible. However, because remote replication is used between the primary storage 15 and data protection storage 16 to realize that the primary storage 15 and data protection storage 16 are located far away from each other, it is possible to construct a system that is not easily affected by a large-scale disaster. The system can be constructed to be less susceptible to the effects of a large-scale disaster.

FIG. 2 (c) shows a system in which a second storage 25 is provided between the first storage 15 and data protection storage 16, and a local copy of SVol 28 is stored in the second storage. By placing the second storage 25 and data protection storage 16 close together and the first and second storage 25 far apart, a system that is less susceptible to large-scale disasters can be constructed.

In either example, the storage monitoring of the invention can be performed by connecting the data protection storage monitoring server 1 to data protection storage.

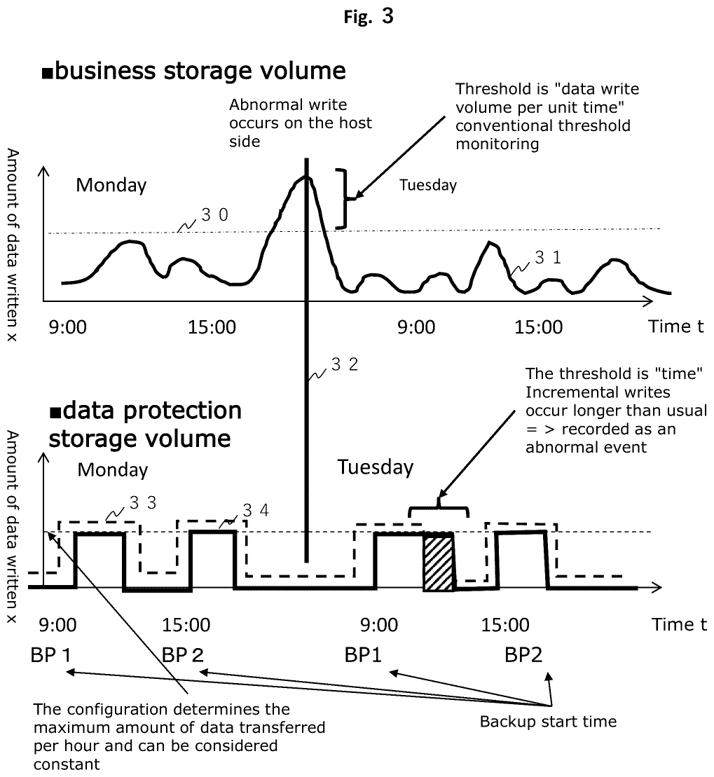

FIG. 3 illustrates a comparison of data write volumes between the business storage volume and the data protection storage volume.

The graph above shows the amount of write data for PVol 17, the business storage volume. The single-dotted line 30 is the amount of write data that indicates the threshold to determine if there is an abnormality, and the solid line 31 is the amount of write data to the business storage volume that was recorded.

The graph below shows the amount of data written to PVol 20, the data protection storage volume. The dotted line 33 shows the time period when normal writing is performed, and the solid line 34 shows the writing time to the recorded data protection storage volume. The business storage volume is directly affected by the input/output of the server executing the business.

On the other hand, the data protection storage volume writes data based on the schedule for backups, so only the portion of the business storage volume that has changed at the maximum available network write capacity will be written to the data protection storage volume. For this reason, there is no random fluctuation in the amount of data written, and the graph shows that only the time to write to the data protection storage volume changes depending on the amount of changes in the business storage volume.

Even if a large amount of data is written in the business storage volume, if the data is only frequently changed to the same address in the volume, only one write to the data protection storage volume is required for that data.

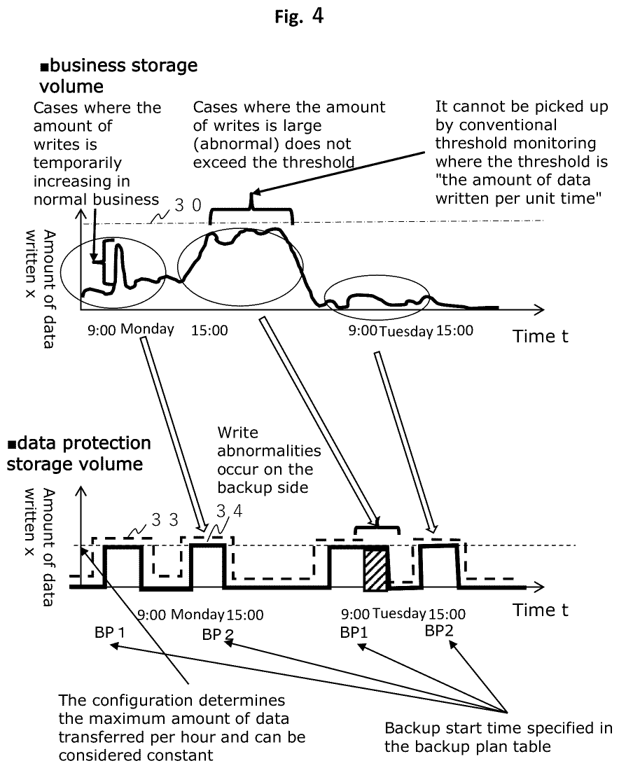

FIG. 4 is a graph illustrating the benefits of monitoring the amount of data written in data protection storage volumes.

The above graph showing the amount of data written to the business storage volume shows a temporary increase in the amount of data written due to normal operations around 10:00 on Monday. Such data writes are not detected as an anomaly because the total amount of data is not large when backups are made to the data protection storage volume. On the other hand, the continuous increase in write data that began around 15:00 was not judged to be abnormal for the business storage volume because it did not exceed the upper limit for the amount of write data shown by the single-dotted line. However, in the data protection storage volume, because there was a large amount of data changes in the business storage volume, the backup plan BP1 backup at 9:00 on Tuesday exceeded the scheduled backup time (shaded area), which can be judged as an error. This can be judged as an anomaly.

Data protection storage volume monitoring allows you to see the cumulative amount of modified areas on business storage volumes, so you can more accurately identify encryption, data compression, deletion, etc. of large amounts of data on business storage volumes due to ransomware attacks, etc.

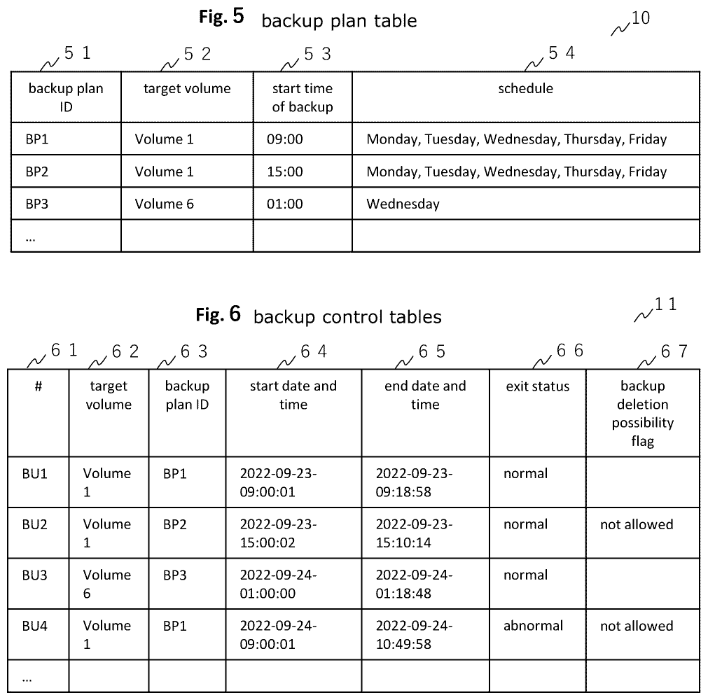

FIG. 5 is an example of a backup plan table in the example of this invention. This table registers a schedule for starting backup. It stores information on backup plan ID 51, target volume 52, start time of backup 53, and schedule 54 that contains the day of the week on which the backup is to be performed.

FIG. 6 is an example of backup control tables in this invention. backup records are stored for each target volume.

The backup ID 61, target volume 62, backup plan ID 63 indicating the schedule in which the backup was performed, start date and time 64, end date and time 65, exit status 66 indicating whether the backup was completed normally or abnormally and the deletion possibility flag indicating whether the backup can be deleted.

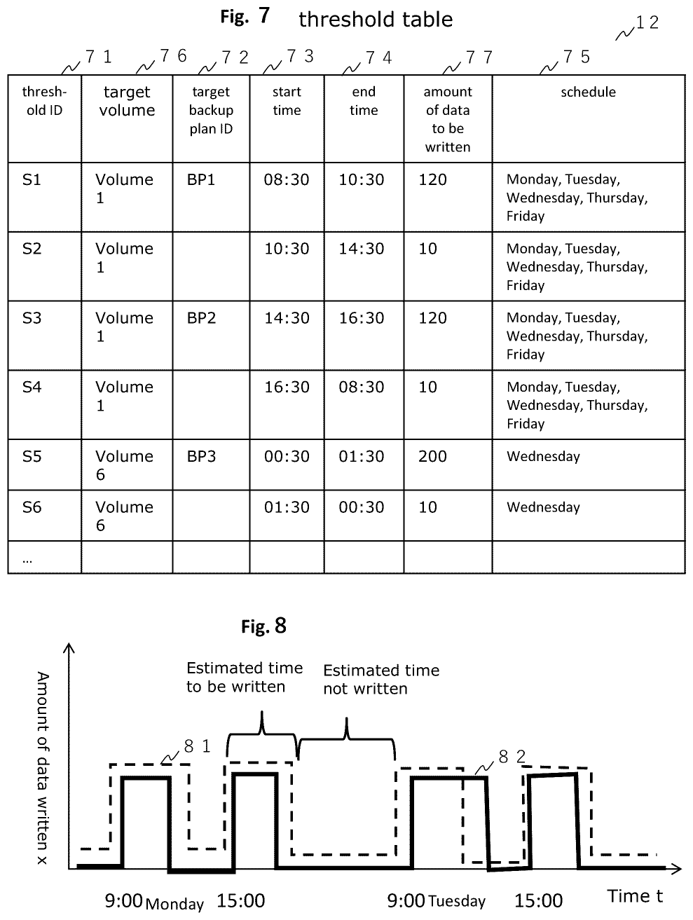

FIG. 7 is an example of the threshold table in this example. For each threshold ID 71, target volume 76, and target backup plan ID 72, a start time 73, which is the time when backup starts, an end time 74, which is the time when backup ends, and the amount of data to be written 77 are defined.

The start time 73 and end time 74 should be defined with some leeway. If the end time 74 is too early, it may not be possible to back up PVol 17 updates that have been changed by normal business processing of the host, resulting in incorrect alert output.

The amount of data to be written is set to the time to perform the write, but may be the storage capacity if the amount of data to be written to the data protection storage volume is unstable.

In addition, the days of the week on which backups are to be performed can be specified in schedule 75 to change the end time, which is the threshold, for each day of the week on which backups are performed. These threshold values and backup plans are set based on preliminary estimates when the backup system is introduced. However, they may be adjusted based on actual operations after the start of operation. For example, machine learning technology can be introduced to improve the accuracy of the threshold values based on past values.

FIG. 8 is a graph illustrating an example of the threshold values set in the threshold table and the metric measurements of the protected storage volume in this example.

The thresholds defined in FIG. 7 for Monday and Tuesday are indicated by the dotted line 81. The solid line 82 is the metric measurements. The mountain portion of the dotted line 81 indicates the times when backups may be executed, and the valley portion indicates the times when backups are not executed.

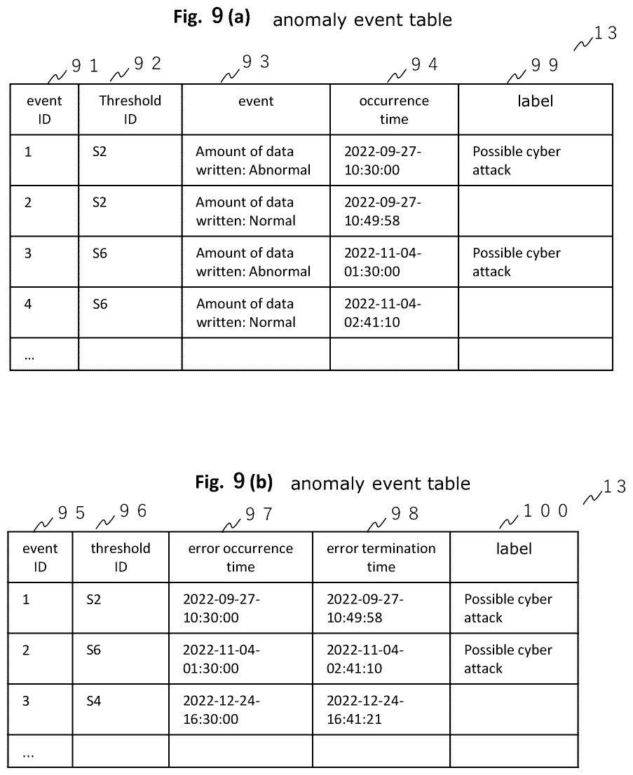

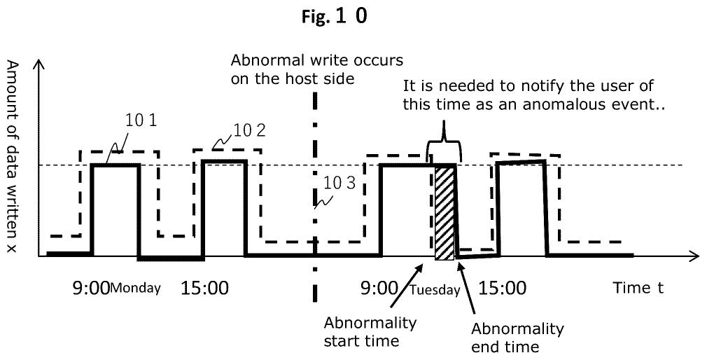

FIGS. 9 (a) and 9 (b) show examples of the anomaly event table in this example.

In FIG. 9 (a), when an event 93 occurs, which is an abnormality in the write volume of backup data that causes the write time of backup data to exceed the scheduled threshold time and a write volume normal event that completes the write of backup data, the event ID 91, the threshold ID 92 corresponding to the event that occurred, and the occurrence time 94 that is the date and time of the occurrence of the event are recorded together with a label 99 indicating whether or not there is a possibility of a cyberattack.

In FIG. 9 (b), when an error occurs, an event ID 95, a threshold ID 96 corresponding to the event that occurred, the error occurrence time 97, which is the date and time the error occurred, the error termination time 98, which is the date and time the backup data writing was completed and returned to normal, and a label 99 indicating whether there is a possibility of cyberattack are recorded.

Either format may be used, but the choice may be based on which format is used by the storage system to manage events.

FIG. 10 shows an example of the anomaly event table values and the metric measurements of the protected storage volume in this example. The following is an example of the occurrence of an anomaly event shown as event 1 and event 2 in the event ID 91 column in FIG. 9 (a) and event 1 in the event ID 95 column in FIG. 9 (b).

The dotted line 102 is the threshold indicating the time period when data writes are scheduled to occur, and the solid line 101 is the metric measurements. In this example, abnormal data was written to PVol 17 on the host side at the time indicated by the Dash-dotted line 103, and backup data writing to PVol 20, which started at 9:00 on Tuesday to back up the written data, did not finish even at 10:30, when the backup was scheduled to end. The backup was scheduled to be completed at 10:30 a.m. on Tuesday, but was not completed until 10:49:58 a.m. An error occurred. The time period during which the anomaly occurred is indicated by a shaded line.

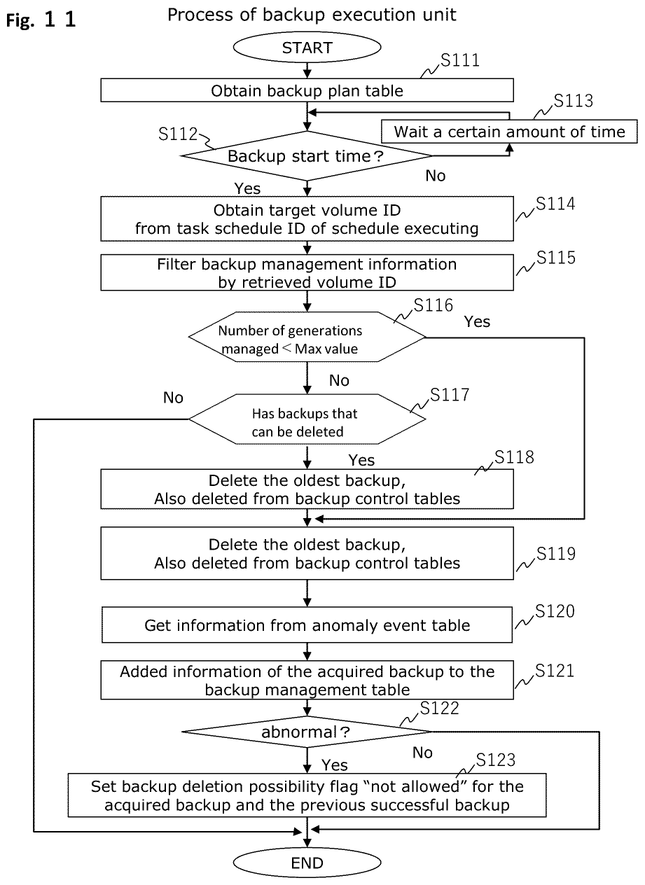

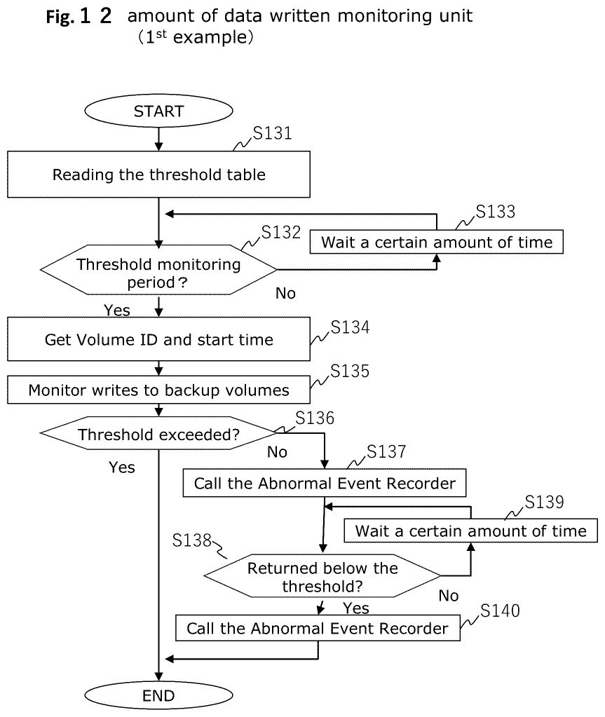

FIG. 11 shows an example of the backup execution unit flowchart in this example.

Obtain information from the backup plan table (S111), and determine if it is time to start the backup (S112), if not, wait a certain period of time (S113), if S112 determines that it is time to start the backup, obtain the volume ID of the backup target from the backup plan ID of the schedule to be executed (S114).

Filtering the backup information in the backup control tables 11 by the retrieved volume ID (S115). Determining if the number of filtered backup generations is less than the maximum value (S116).

If the maximum value is not exceeded, acquire a local copy SVol 18 of PVol 17 in the first storage (Business Storage) and acquire a backup in Data Protection Storage (S119). Get anomaly information from Anomaly Event Table 13 (S120), storing the information of the acquired backup in the backup control tables 11 (S121). Determine whether the acquired backup is abnormal or not (S122), and if abnormal, set the deletion possibility flag of the acquired backup and one previous normal backup to “Not Allowed” (S123). If the backup is not abnormal, the process is terminated.

Checks whether there is a backup that can be deleted if the number of backup generations exceeds the maximum value in S116 based on the backup deletion possibility flag 67 of Backup Control Tables 11 (S117). Delete the oldest backup if there is one that can be deleted, and delete it from backup control tables 11 as well (S118). After this, backup processing after S119 is performed.

If there is no backup that can be deleted in S117, the system outputs an error and exits.

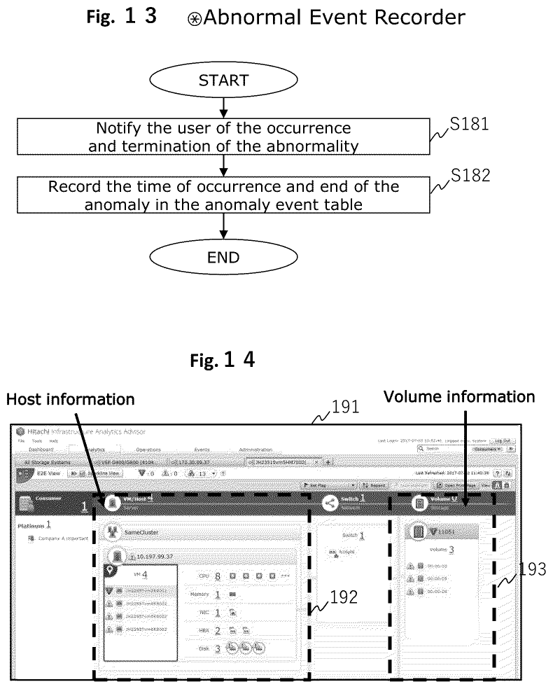

FIG. 12 is an example of a flowchart of the amount of data written monitoring unit in the example of this invention.

Read threshold table 12 (S131), and determine if it is the period subject to threshold monitoring (S132). If not, wait a certain period of time (S133). If it is the period subject to threshold monitoring, obtain target volume ID 52 and backup start time 53 from target backup plan ID 72 in threshold table 12 (S134). Monitors writes to the obtained volume ID 52.

Determine if the monitored value exceeded the threshold value (S136). The threshold value may be determined by judging whether the write is complete by the end time 74 of the threshold table, or by the capacity of the written data. If not, the abnormal event recorder is invoked (S137), and determine again if the monitored value have returned to below the threshold (S138). If writing is not complete, wait a certain period of time (S139). If writing is complete, the abnormal event recorder is invoked (S140). If the writing is completed at S136, the process is terminated.

FIG. 13 shows an example of the abnormal event recorder flowchart in this example. Notifies the user's Monitoring terminal 5 of the occurrence and termination of an abnormality (S181), and records the occurrence/termination time of the abnormality in the anomaly event table 13 (S182).

FIG. 14 is an example of the output screen in this example. When an abnormality occurs and the abnormal event recorder notifies the user, volume information 193 including the identifier of the volume in which the abnormality occurred and host information 192 including the identifier of the host corresponding to the volume are output on the abnormality notification screen 191. This enables the user to identify the affected host and application.

The correspondence between the volume and the host is obtained by acquiring the Lun (Logical unit number) and host group correspondence information from the volume information, obtaining the volume and WWN (World Wide Name) correspondence information from the host group information, and referring to the WWN and host correspondence information. The information is obtained by referring to the information on the host group.

It is also possible to identify the application because host and application are often operated in correspondence.

### EXAMPLE 2

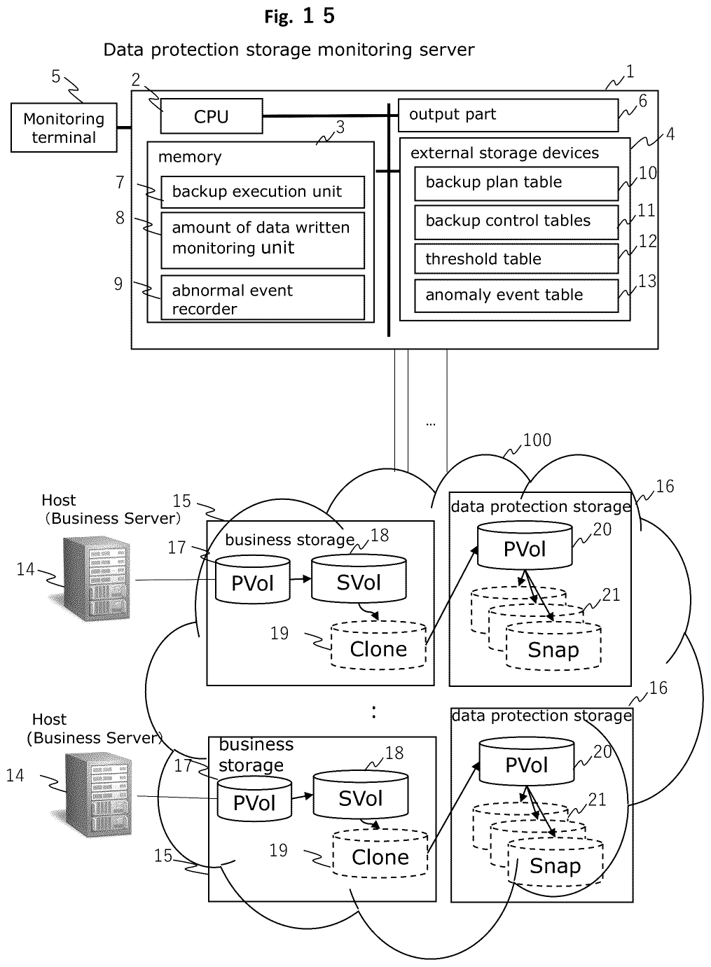

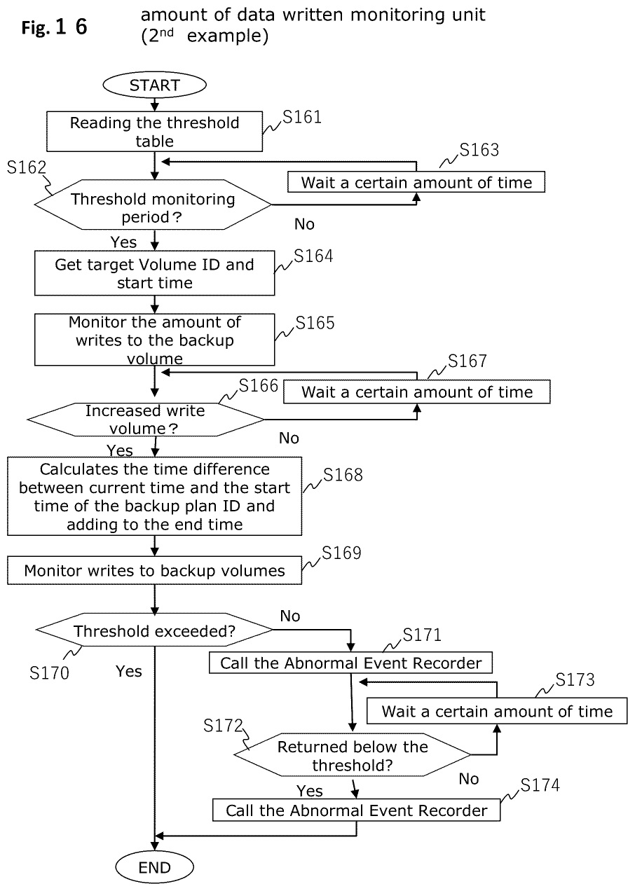

FIG. 15 is an example of a block diagram showing an example of the system configuration in this example. This example is for a case where business storage and data protection storage are in the cloud computing system 100. If multiple systems are in the cloud computing system, there may be a delay when backup instructions are issued from Data Protection Storage.

The backup process itself may also be affected by other systems and may not be executed at the scheduled time.

FIG. 16 is an example of a flowchart of the amount of data written monitoring unit in this example.

The difference from the process of the amount of data written monitoring unit in the first example described in the flowchart in FIG. 12 is that when monitoring is performed at the time of the threshold monitoring target, the amount of writes to the backup volume is monitored (S165), and whether the amount of writes has increased is determined (S166). If the write volume has not increased, waits for a certain period of time (S167).

If the write volume has increased, determines the difference from the start time 73 of the backup plan ID 72 and adds the difference to the end time 74 to correct the end time 74, which is the standard for determining whether an abnormality has occurred (S168).

This process can improve the accuracy of abnormality determination even for backup systems implemented in the cloud computing system, which are susceptible to the influence of other systems.

Although the above examples are given, the invention is not limited to the aforementioned embodiments.

For example, in FIG. 12, the amount of data written to the backup volume is monitored, but this can also be monitored using the write transfer rate, which is the rate at which data is written to the backup volume, using the fact that data is written during the backup cycle and the flow rate reaches its peak. The backup may also be monitored using the write transfer rate, which is the rate at which data is written to the backup volume.

Based on the abnormal events recorded by the invention, a temporary response may be automatically taken, for example, while the user investigates and determines the authenticity of the abnormal event and the response. For example, there are means such as notifying the user by e-mail or automatically adding capacity and extending the period of time for which backups remain for a predetermined period of time.

### REFERENCE SIGNS LIST

1 Data Protection Storage Monitoring Server,
2 CPU,
3 Memory,
4 External storage devices,
5 Monitoring terminal,
6 Output part,
7 Backup execution unit,
8 Amount of data written monitoring unit,
9 Abnormal Event Recorder,
10 Backup plan table,
11 Backup control tables,
12 Threshold table,
13 Anomaly event table,
14 host,
15 Business storage,
16 Data protection storage,
17, 20 PVol,
18 SVol,
19 Clone,
21 Snap

1. A storage system comprising:
a first storage connected to the server running the application,
a data protection storage to get a backup of the first storage,
a monitoring server monitoring the data protection storage,
wherein the monitoring server comprising:
backup execution unit that backup data from the first storage to the data protection storage,
an amount of data written monitoring unit determines abnormality when the amount of data written to the data protection storage exceed predetermined amount and,
an output part issue alert when the amount of data written monitoring unit determines an abnormality.

2. A storage system described in claim 1,
the monitoring server comprising backup execution unit,
a disk volume for backup,
a backup plan table storing backup start time and,
a threshold table storing backup start time and backup end time,
wherein the backup execution unit refer to the backup plan table and starts backup the disk volume at the backup start time,
the amount of data written monitoring unit detects abnormality based on whether the completion of writing to the data protection storage exceeds backup end time in the threshold table or not.

3. A storage system described in claim 2,
the monitoring server accepts changes to the backup end time from the connected monitoring terminal,
and updates the backup end time in the threshold table.

4. A storage system described in claim 2 comprising:
a backup control tables storing a deletion possibility flag indicating whether the backup can be deleted or not,
when the amount of data written monitoring unit detects an abnormality, the deletion possibility flag of the most recent generation of backup control tables is changed to non-deletable.

5. A storage system described in claim 2,
the first storage has a first physical volume accessed by the server and a first local volume associated with the first physical volume,
the data protection storage has a second physical volume storing backups of the first physical volume,
the backup execution unit obtains a backup from the virtual volume of the first local volume to the second physical volume.

6. A storage system described in claim 2,
the first storage has a first physical volume that is accessed by the server,
the data protection storage has a second local volume corresponding to the first physical volume and a second physical volume storing backups,
the backup execution unit obtains a backup from the virtual volume of the local volume to a second physical volume.

7. A storage system described in claim 2,
a first physical volume accessed by the server, which is stored in the first storage,
a third storage including a third physical volume corresponding to the first physical volume and a third local volume corresponding to the third physical volume,
wherein the data protection storage has a second physical volume to store backups and,
the backup execution unit obtains a backup from the virtual volume of the local volume to a second physical volume.

8. A storage system described in claim 2,
the first storage and the data protection storage are located in a cloud computing system,
the amount of data written monitoring unit detects a delay in the start of data writing, detects an abnormality at a time later than the backup end time of the threshold table.

9. A storage system described in claim 5,
when the amount of data written monitoring unit detects an abnormality, alert output part outputs the identifier of the host associated with the first physical volume.

10. A storage monitoring method comprising:
a first storage connected to the server running the application,
a data protection storage receiving a backup of the first storage,
a monitoring server monitoring data protection storage,
an amount of data written monitoring unit of the monitoring server determining abnormality when the amount of data written to the data protection storage exceed predetermined amount and,
an output part issuing alert when the amount of data written monitoring unit determines an abnormality.
